(19) United States
(12) Patent Application Publication
(10) Pub. No.: US 2007/0229439 A1
(43) Pub. Date: Oct. 4, 2007

(54) GAMMA REFERENCE VOLTAGE GENERATING DEVICE AND LIQUID CRYSTAL DISPLAY USING THE SAME

(76) Inventors: Fansen Wang, Taipei County (TW); Chang-San Chen, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,478

(22) Filed: Mar. 29, 2006

(51) Int. Cl. G09G 3/36

(52) U.S. Cl. 345/100

(57) ABSTRACT

A Gamma reference voltage generating device related to a liquid crystal display is provided. The device comprises a voltage dividing device and multiple voltage followers. The voltage dividing device provided multiple voltage dividing signals comprises multiple voltage dividing elements (usually resisters or capacitors) connected in series. An optional image data processing operational amplifier, also referred as dummy or repair OP-AMP, in each data driver ICs is utilized as a voltage follower to receive one of the above voltage dividing signals and output a Gamma reference voltage respectively. An optional image data processing operational amplifier in the data driver integrated circuit is utilized according to the present invention, such that the amount of operational amplifier ICs that is required is significantly reduced. Thus, the circuit cost and the power consumption are effectively reduced, as well as the area of the printed circuit board.

### BACKGROUND OF THE INVENTION

1. Field of Invention

The present invention relates to a Gamma reference voltage generating device and a liquid crystal display using the same, more particularly to a Gamma reference voltage generating device suitable for a liquid crystal display.

2. Description of Related Art

The liquid crystal display (LCD) related products can be seen everywhere in our daily life. To enable an LCD to properly display images, a digital signal of the image data should be converted into an analog signal being sufficient for driving the liquid crystals. However, during the digital-to-analog converting process, several Gamma reference voltages at different levels are required to be used for a digital to analog converter (DAC).

A Gamma reference voltage typically requires more than 10 sets of fixed voltages at different levels, in a sequence from high to low. Conventionally, voltage drops generated by several elements connected in series are utilized to get a Gamma reference voltage. Several operational amplifier (OP-AMP) integrated circuits (IC) are required to be additionally arranged into the circuit, as shown in FIG. 1, to avoid a voltage drop in the reference voltage caused by the loading effect, resulting in incorrectness of liquid crystal driving. To generate multiple sets of voltages generally requires a corresponding number of resisters and OP-AMPs, and then the generated Gamma reference voltages are sent to a data driver IC to generate multiple sets of gray level voltages being used for the DAC.

FIG. 1 is a circuit diagram of a conventional Gamma reference voltage generating device. Referring to FIG. 1, several resisters 110 are connected in series to get several Gamma reference voltages 115 with different potentials through voltage drops level by level. An OP-AMP 120 with high input resistance is used as a voltage follower in order to avoid a loading effect. A Gamma reference voltage 115 is inputted into the OP-AMP 120, and a Gamma reference voltage 125 is outputted. The Gamma reference voltage 125 is connected to each data driver IC 130 to be used for the DAC 140 therein. In the figure, a built-in optional image data processing OP-AMP 150, alternatively referred as dummy or repair OP-AMP, of the data driver IC 130 is disposed for the purpose of the symmetry of the layout and uniform characteristics of the OP-AMP. By disposing the dummy OP-AMPs, the characteristic of the OP-AMPs for another device (e.g. DAC 140) in the data driver IC 130 can be implemented exactly. The optional image data processing OP-AMPs is left unused in prior art.

As known from the above, a conventional Gamma reference voltage generating device additionally requires multiple resisters and OP-AMPs on the printed circuit board (PCB). However, since many elements on the PCB are used, some disadvantages such as high circuit cost and high power consumption exist. Moreover, a large area of the PCB is occupied.

### SUMMARY OF THE INVENTION

Accordingly, an object of the present invention is to provide a Gamma reference voltage generating device and a liquid crystal display (LCD) using the same, such that the circuit cost can be reduced.

Another object of the present invention is to provide a Gamma reference voltage generating device and an LCD using the same, so as to reduce the power consumption.

Still another object of the present invention is to provide a Gamma reference voltage generating device and an LCD using the same, so as to save the area of the printed circuit board (PCB).

A Gamma reference voltage generating device is provided, which utilizes an operational amplifier (OP-AMP), e.g. optional image data processing OP-AMP, dummy OP-AMP or repair OP-AMP, in the data driver IC as a voltage follower of the Gamma reference voltage generating device.

According to a preferred embodiment of the present invention, the Gamma reference voltage generating device includes a voltage dividing device and multiple voltage followers. The voltage dividing device includes multiple voltage dividing elements (usually resisters or capacitors) collected in series, for providing multiple voltage dividing signals through the voltage drop level by level. An optional data processing OP-AMP in each data driver IC is utilized as a voltage follower, used for receiving an above-mentioned voltage dividing signal and outputting a Gamma reference voltage respectively. Generally, a medium or large size LCD panel includes 8-12 data driver ICs therein, and each of the data driver ICs has at least two built-in optional data processing OP-AMPs. Therefore, as compared with a conventional circuit, the amount of the OP-AMP ICs that is required is significantly reduced, thereby achieving the object of lowering costs. Also, the power consumption is naturally reduced due to a smaller number of elements being used. Additionally, since the amount of the OP-AMP ICs that is required is reduced, the area of the PCB is effectively reduced, such that minimization of the module can be further achieved.

An optional data processing OP-AMP in the data driver IC is utilized according to the present invention; thus the amount of the OP-AMP ICs that is required is significantly reduced. However, in practical circuit application, the optional data processing OP-AMP may be directly applied without any modification. Therefore, the built-in OP-AMP in the data driver IC can be sufficiently utilized, such that additional OP-AMP ICs are saved; the circuit cost and the power consumption are effectively reduced; and the area of the printed circuit board is diminished as well.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit diagram of a conventional Gamma reference voltage generating device.

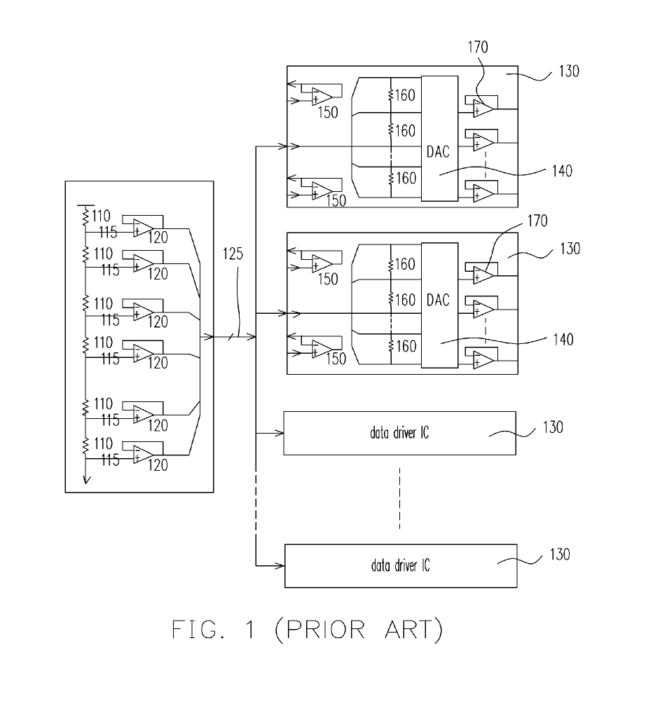

FIG. 2 is a circuit diagram of a Gamma reference voltage generating device according to a preferred embodiment of the present invention.

FIG. 3 is a circuit diagram of a Gamma reference voltage generating device according to another preferred embodiment of the present invention.

### DESCRIPTION OF EMBODIMENTS

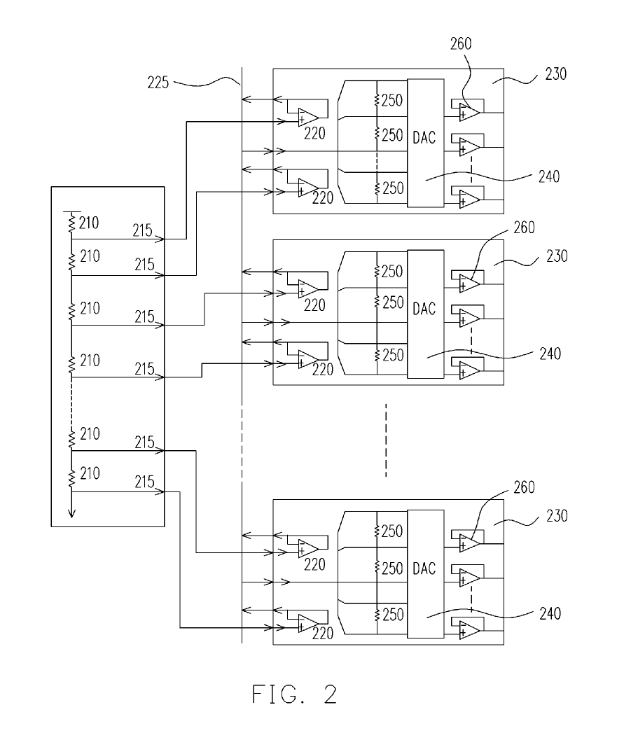

Refer to FIG. 2, it is a circuit diagram of a Gamma reference voltage generating device according to a preferred embodiment of the invention. In the figure, several resisters 210 are connected in series, and several Gamma reference voltages 215 with different voltage values are obtained through the voltage drop level by level. In order to avoid a loading effect, an OP-AMP with high input resistance 220 is employed as a voltage follower, wherein the OP-AMP 220 utilizes the built-in OP-AMP in the data driver IC 230 for generating the Gamma reference voltage 225. In the embodiment, for example, the OP-AMP 220 utilizes an optional data processing OP-AMP, alternatively referred as a dummy or repair OP-AMP, in a data driver IC 230. The optional data processing OP-AMP is sometimes disposed for the symmetry of the layout or uniform characteristics of the OP-AMP. Wherein, by disposing the dummy OP-AMPs, the characteristic of the OP-AMPs for another device (e.g. DAC 240) in the data driver IC 230 can be implemented exactly. The optional data processing OP-AMPs is left unused in prior art. The Gamma reference voltage 215 is inputted into the OP-AMP 220, and a Gamma reference voltage 225 is outputted. The Gamma reference voltage 225 is connected to each data driver IC 230 and used by the digital to analog converter 240 therein.

A Gamma reference voltage generating device disclosed according to the present invention is described in the above preferred embodiment. The device utilizes the built-in OP-AMP 220 in the data driver IC 230 as an OP-AMP for generating the Gamma reference voltage 225. Generally, a medium or large size LCD panel includes 8-12 data driver ICs, and each of the data driver ICs has at least two build-in optional data processing OP-AMPs, which are not used in a conventional circuit. Thus, these dummy OP-AMPs can be used for providing 16-24 sets, or even up to 48 sets of Gamma reference voltages. In this way, the frequency of using OP-AMP ICs will be significantly reduced.

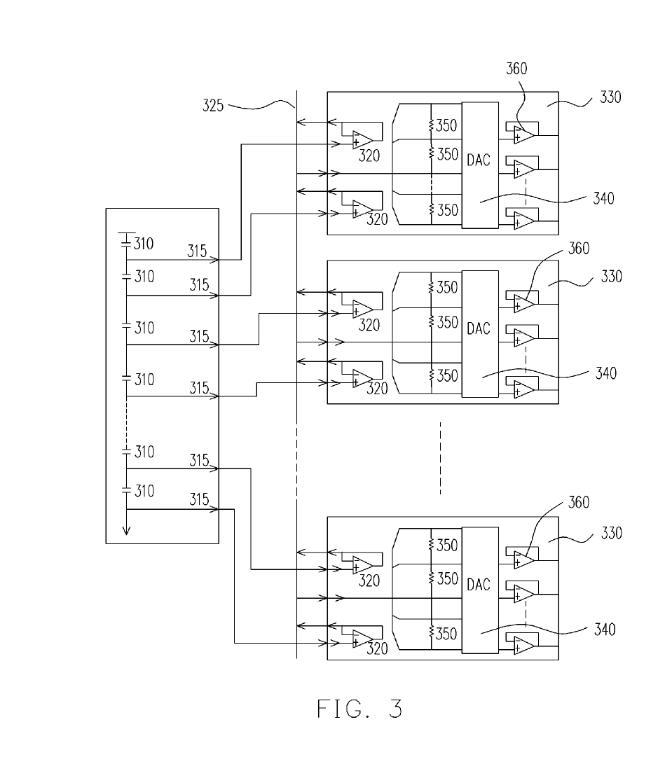

Refer to FIG. 3, it is a circuit diagram of a Gamma reference voltage generating device according to another preferred embodiment. In the figure, several capacitors 310 are connected in series, and several Gamma reference voltages 315 with different voltage values are obtained through the voltage drop level by level. In order to avoid a loading effect, an OP-AMP 320 with high input resistance is employed as a voltage follower, wherein the OP-AMP 320 utilizes an optional data processing OP-AMP, alternatively referred as a dummy or repair OP-AMP, in a data driver IC 330. The optional data processing OP-AMP is sometimes disposed for the symmetry of the layout or uniform characteristics of the OP-AMP. The Gamma reference voltage 315 is inputted into the OP-AMP 320, and a Gamma reference voltage 325 is outputted. The Gamma reference voltage 325 is connected to each data driver IC 330 and used by the digital analog converter 340 therein.

As known from the above, by utilizes the built-in OP-AMP in the data driver IC as the voltage follower for generating the Gamma reference voltage, the Gamma reference voltage generating device of the present invention no need additional OP-AMPs on the printed circuit board (PCB). Many advantages such as reducing circuit cost and decreasing power consumption are achieved. Moreover, the present invention can reduce large area of the PCB.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A Gamma reference voltage generating device for providing a plurality of Gamma reference voltages for at least a data driver integrated circuit, the Gamma reference voltage generating device comprising:
a voltage dividing device out of the data driver integrated circuit for providing a plurality of voltage dividing signals; and
a plurality of voltage followers in the data driver integrated circuit, wherein each of the voltage followers used for receiving one of the voltage dividing signals and outputting the corresponding Gamma reference voltage respectively.

2. The Gamma reference voltage generating device as claimed in claim 1, wherein the voltage followers are implemented as a plurality of optional data processing operational amplifiers (OP-AMPs) in the data driver integrated circuit.

3. The Gamma reference voltage generating device as claimed in claim 2, wherein the optional data processing OP-AMPs are the dummy OP-AMPs in the data driver integrated circuit, and the optional data processing OP-AMPs are sometimes disposed for the symmetry of the layout or uniform characteristics of the OP-AMP in the data driver integrated circuit.

4. The Gamma reference voltage generating device as claimed in claim 2, wherein the optional data processing OP-AMPs are the repair OP-AMPs in the data driver integrated circuit.

5. The Gamma reference voltage generating device as claimed in claim 1, wherein the voltage dividing device comprises a plurality of voltage dividing elements, and the voltage dividing elements are connected in series, and a voltage dropped by one of the voltage dividing elements is outputted as one of the voltage dividing signals.

6. The Gamma reference voltage generating device as claimed in claim 5, wherein the voltage dividing elements are implemented as a plurality of resisters.

7. The Gamma reference voltage generating device as claimed in claim 5, wherein the voltage dividing elements are implemented as a plurality of capacitors.

8. The Gamma reference voltage generating device as claimed in claim 1, wherein one of the voltage followers comprises an operational amplifier, and one of the voltage dividing signals is inputted through a positive input of the operational amplifier, while the Gamma reference voltage is outputted through an output of the operational amplifier and is fed back to a negative input of the operational amplifier.

9. The Gamma reference voltage generating device as claimed in claim 8, wherein the operational amplifier is respectively disposed in a plurality of data driver integrated circuits.

10. A liquid crystal display, comprising:
a voltage dividing device, for providing a plurality of voltage dividing signals; and
a plurality of data driver integrated circuits, wherein each of the data driver integrated circuits comprises a plurality of voltage followers, and each of the voltage followers is used for receiving one of the voltage dividing signals and outputting a Gamma reference voltage respectively.

11. The liquid crystal display as claimed in claim 10, wherein the voltage followers are implemented as a plurality of optional data processing operational amplifiers (OP-AMPs) in the data driver integrated circuits.

12. The liquid crystal display as claimed in claim 11, wherein the optional data processing OP-AMPs are the dummy OP-AMPs in the data driver integrated circuits, and the optional data processing OP-AMPs are sometimes disposed for the symmetry of the layout or uniform characteristics of the OP-AMP in the data driver integrated circuits.

13. The liquid crystal display as claimed in claim 11, wherein the optional data processing OP-AMPs are the repair OP-AMPs in the data driver integrated circuits.

14. The liquid crystal display as claimed in claim 10, wherein the voltage dividing device comprises a plurality of voltage dividing elements, and the voltage dividing elements are connected in series, and a voltage dropped by one of the voltage dividing elements is outputted as one of the voltage dividing signals.

15. The liquid crystal display as claimed in claim 14, wherein the voltage dividing elements are implemented as a plurality of resisters.

16. The liquid crystal display as claimed in claim 14, wherein the voltage dividing elements are implemented as a plurality of capacitors.

17. The liquid crystal display as claimed in claim 10, wherein the voltage follower comprises an operational amplifier, and one of the voltage dividing signals is inputted through a positive input of the operational amplifier, while the Gamma reference voltage is outputted through an output of the operational amplifier and is fed back to a negative input of the operational amplifier.
